(19) United States
(12) Patent Application Publication
(10) Pub. No.: US 2025/0217629 A1
(43) Pub. Date: Jul. 3, 2025

(54) SYNTHETIC MEDICAL DATA GENERATION USING A MULTIMODAL TRANSFORMER NETWORK

(71) Applicant: Siemens Healthineers AG, Forchheim (DE)

(72) Inventors: Manuela Daniela Danu, Brasov (RO); Sanjeev Kumar Karn, Plainsboro, NJ (US); Kusuma P, Bengaluru (IN); Oladimeji Farri, Upper Saddle River, NJ (US)

(21) Appl. No.: 18/402,837

(22) Filed: Jan. 3, 2024

(51) Int. Cl. G06N 3/0455; G06F 40/284; G06T 11/00

(52) U.S. Cl. CPC G06N 3/0455; G06T 11/00; G06F 40/284

(57) ABSTRACT

Systems and methods for generating synthetic medical data are provided. One of 1) an input medical image, 2) input medical text, or 3) an input medical image/text pair is received. Features are extracted from the received one of 1) the input medical image, 2) the input medical text, or 3) the input medical image/text pair. One of A) synthetic medical text, B) a synthetic medical image, or C) a synthetic medical image/text pair is generated for the received one of 1) the input medical image, 2) the input medical text, or 3) the input medical image/text pair respectively based on the extracted features and using a trained machine learning based model. The generated one of A) the synthetic medical text, B) the synthetic medical image, or C) the synthetic medical image/text pair is output.

### TECHNICAL FIELD

The present invention relates generally to synthetic medical data generation, and in particular to synthetic medical data generation using a multimodal transformer network.

### BACKGROUND

In the clinical domain, machine learning based models have been proposed for performing various medical tasks. More powerful and comprehensive machine learning based models that better understand complex medical conditions and support healthcare professionals in diagnosis, treatment planning, and prognosis prediction can be created by using paired medical images and medical text. However, a significant challenge associated with training machine learning based models using paired medical images and medical text is the lack of available labelled datasets, primarily due to patient privacy concerns.

### BRIEF SUMMARY OF THE INVENTION

In accordance with one or more embodiments, systems and methods for generating synthetic medical data are provided. One of 1) an input medical image, 2) input medical text, or 3) an input medical image/text pair is received. Features are extracted from the received one of 1) the input medical image, 2) the input medical text, or 3) the input medical image/text pair. One of A) synthetic medical text, B) a synthetic medical image, or C) a synthetic medical image/text pair is generated for the received one of 1) the input medical image, 2) the input medical text, or 3) the input medical image/text pair respectively based on the extracted features and using a trained machine learning based model. The generated one of A) the synthetic medical text, B) the synthetic medical image, or C) the synthetic medical image/text pair is output.

In one embodiment, one of the input medical image or the input medical image/text pair is received. One or more of dense features, tokens embeddings of textual labels of anatomical objects of interest identified in the one of the input medical image or the image of the input medical image/text pair, region features of the anatomical objects of interest, or region coordinates of the anatomical objects of interest are extracted from one of the input medical image or an image of the input medical image/text pair.

In one embodiment, one of the input medical text or the input medical image/text pair is received. An SLS (structured language sequence) representation is extracted from one of the input medical text or text of the input medical image/text pair. The SLS representation is encoded into token embeddings.

In one embodiment, synthetic image features are generated using the trained machine learning based model. The synthetic medical image is generated based on the synthetic image features using a machine learning based image generator network.

In one embodiment, the trained machine learning based model is trained by: during a first training stage, training the machine learning based model using a training image/text pair comprising a training medical image and training medical text. During a second training stage, the machine learning based model is trained using 1) a modified version of the training medical image and 2) the training medical text and the machine learning based model is trained using 1) a modified version of the training medical text and 2) the training medical image.

In one embodiment, the machine learning based model is trained by generating a synthetic medical image by the machine learning based model from 1) the modified version of the training medical image and 2) the training medical text, comparing the synthetic medical image with the training medical text, and comparing the synthetic medical image with the training medical image.

In one embodiment, the machine learning based model is trained by generating synthetic medical text by the machine learning based model from 1) the modified version of the training medical text and 2) the training medical image, comparing the synthetic medical text with the training medical text, and comparing an SLS (structured language sequence) representation of the synthetic medical text with an SLS representation of the training medical text.

In one embodiment, the trained machine learning based model is a multimodal transformer network.

In accordance with one or more embodiments, systems and methods for training a machine learning based model for generating synthetic medical data are provided. A training medical image/text pair is received. A machine learning based model is trained for generating synthetic medical text and a synthetic medical image based on the training medical image/text pair. The trained machine learning based model is output.

In one embodiment, the training medical image/text pair comprises a training medical image and training medical text. During a first training stage, the machine learning based model is trained using the training image/text pair. During a second training stage, the machine learning based model is trained using 1) a modified version of the training medical image and 2) the training medical text and the machine learning based model is trained using 1) a modified version of the training medical text and 2) the training medical image.

In one embodiment, the machine learning based model is trained by generating a synthetic medical image by the machine learning based model from 1) the modified version of the training medical image and 2) the training medical text, comparing the synthetic medical image with the training medical text, and comparing the synthetic medical image with the training medical image.

In one embodiment, the machine learning based model is trained by generating synthetic medical text by the machine learning based model from 1) the modified version of the training medical text and 2) the training medical image, comparing the synthetic medical text with the training medical text, and comparing an SLS (structured language sequence) representation of the synthetic medical text with an SLS representation of the training medical text.

These and other advantages of the invention will be apparent to those of ordinary skill in the art by reference to the following detailed description and the accompanying drawings.

### BRIEF DESCRIPTION OF THE DRAWINGS

FIG. 1 shows a workflow for generating synthetic medical data, in accordance with one or more embodiments;

FIG. 2 shows a method for generating synthetic medical data, in accordance with one or more embodiments;

FIG. 3 shows a workflow for extracting an SLS representation from input text, in accordance with one or more embodiments;

FIG. 4 shows a workflow for training a machine learning based model for generating synthetic medical data, in accordance with one or more embodiments;

FIG. 5 shows a method for training a machine learning based model for generating synthetic medical data, in accordance with one or more embodiments;

FIG. 6 shows an artificial neural network that may be used to implement one or more machine learning models described herein, in accordance with one or more embodiments;

FIG. 7 shows a convolutional neural network that may be used to implement one or more machine learning models described herein, in accordance with one or more embodiments;

FIG. 8 shows a generative adversarial network that may be used to implement one or more machine learning models described herein, in accordance with one or more embodiments;

FIG. 9 shows a recurrent machine learning model that may be used to implement one or more machine learning models described herein, in accordance with one or more embodiments; and

FIG. 10 shows a high-level block diagram of a computer that may be used to implement one or more embodiments.

### DETAILED DESCRIPTION

The present invention generally relates to methods and systems for synthetic medical data generation using a multimodal transformer network. Embodiments of the present invention are described herein to give a visual understanding of such methods and systems. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

Embodiments described herein provide for a multimodal transformer network for generating synthetic medical data. The multimodal transformer network is trained to perform both image-to-text and text-to-image generation tasks as sequence generation tasks by representing image/text pairs as unified token sequences. Advantageously, such synthetic medical data may augment real medical data for training machine learning based networks for performing various tasks. Further, such synthetic medical data can replace real annotated medical data for training machine learning models, particularly where obtaining ground truth data is difficult. Such synthetic medical data facilitates the training of machine learning models to quickly learn to perform a target task while addressing low resource issues. Such synthetic medical data reduces the need for manual annotation and data gathering while improving fairness, privacy, and ethical labeling concerns.

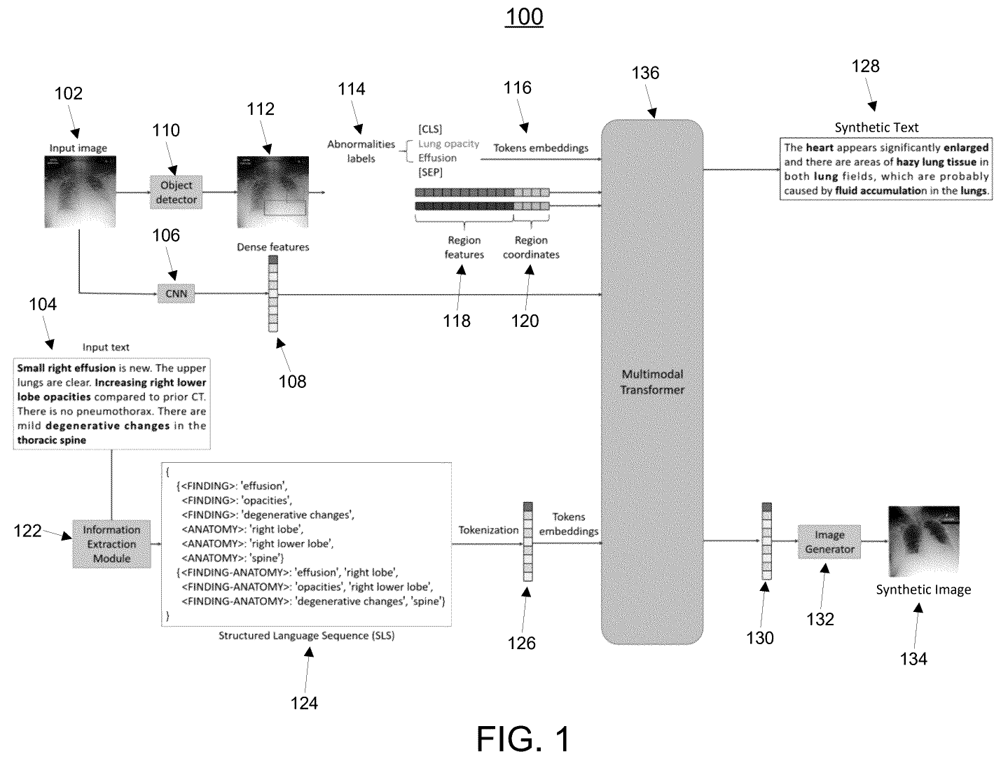

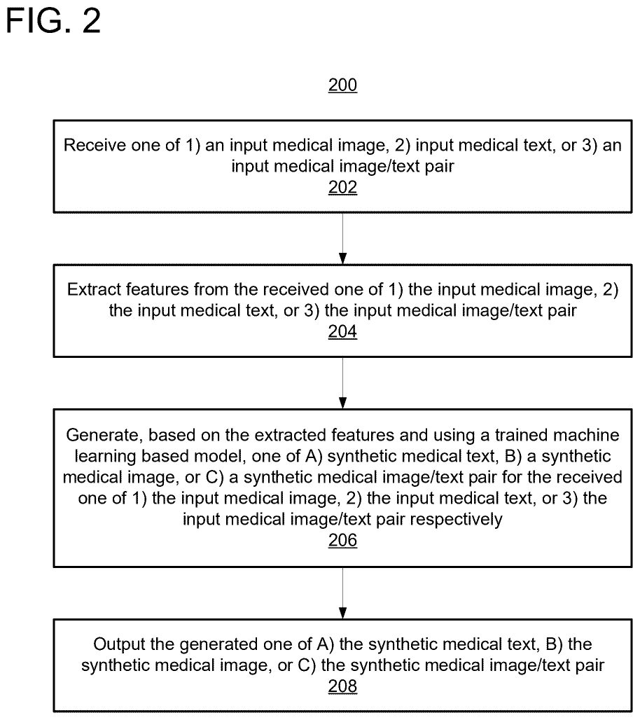

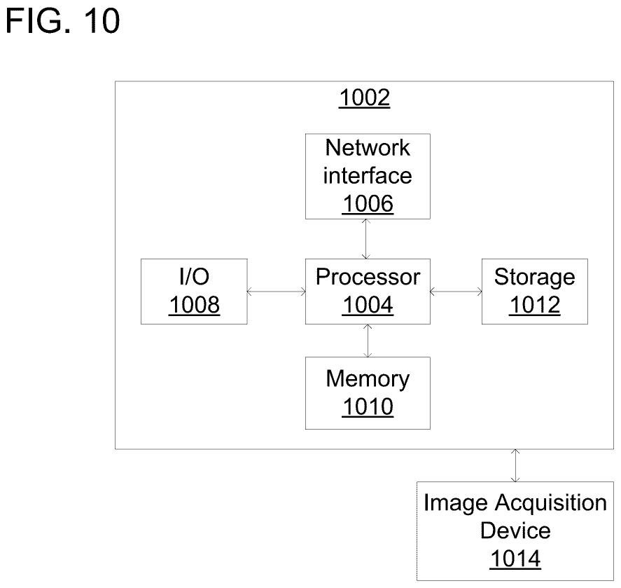

FIG. 1 shows a workflow 100 for generating synthetic medical data, in accordance with one or more embodiments. FIG. 2 shows a method 200 for generating synthetic medical data, in accordance with one or more embodiments. The steps of method 200 may be performed by one or more suitable computing devices, such as, e.g., computer 1002 of FIG. 10. FIG. 1 and FIG. 2 will be described together.

At step 202 of FIG. 2, one of 1) an input medical image, 2) input medical text, or 3) an input medical image/text pair is received. In one example, as shown in workflow 100 of FIG. 1, the input medical image may be input image 102, the input medical text may be input text 104, and the input medical image/text pair may be input image 102 and input text 104. The image and the text of the input medical image/text pair are paired such that the image depicts, and the text describes, a same medical condition(s).

The input medical image (including the image in the input medical image/text pair) may depict any anatomical object of interest, such as, e.g., organs, bones, vessels, tumors or other diseases and abnormalities, etc. The input medical image may be of any suitable modality, such as, e.g., CT (computed tomography), MRI (magnetic resonance imaging), US (ultrasound), x-ray, or any other medical imaging modality or combinations of medical imaging modalities. The input medical image may be a 2D (two dimensional) image and/or a 3D (three dimensional) volume.

The input medical text (including the text of the input medical image/text pair) may comprise any textual medical information, such as, e.g., clinician notes, reports, test results, medical records, etc. In one embodiment, the input medical text is in an arbitrary, unstructured format in natural language. The input medical text may be received as text, voice, or any other suitable form. One example of the input medical text is shown in FIG. 1 as follows: “Small right effusion is new. The upper lungs are clear. Increasing right lower lobe opacities compared to prior CT. There is no pneumothorax. There are mild degenerative changes in the thoracic spine.”

The received one of the input medical image, the input medical text, or the input medical image/text pair can be received by, for example, receiving the received one of the input medical image, the input medical text, or the input medical image/text pair from a user interacting with a computer (e.g., via I/O 1008 of computer 1002 of FIG. 10), by loading the received one of the input medical image, the input medical text, or the input medical image/text pair from a storage or memory of a computer system (e.g., memory 1010 and/or storage 1012 of computer 1002 of FIG. 10), and/or by loading the received one of the input medical image, the input medical text, or the input medical image/text pair from a remote computer system (e.g., computer 1002 of FIG. 10). In another example, the input medical image may be received directly from an image acquisition device (e.g., image acquisition device 1014 of FIG. 10) as the medical image is acquired.

At step 202 of FIG. 2, features are extracted from the received one of 1) the input medical image, 2) the input medical text, or 3) the input medical image/text pair.

In one embodiment, the features extracted from the input medical image (including the image of the input medical image/text pair) may comprise one or more of image features, region features, region coordinates, or textual labels. For example, the features extracted from the input medical image may be represented as follows:

$$Image Representation =$$

$$[ CLS ] + [ tokens embeddings for textual labels ] + [ SEP ] +$$

$$[ region features and region coordinates ] + [ SEP ] + [ image features ]$$

where CLS refers to a classification token indicating a beginning of the features and SEP refers to a separate token to delineate between the features.

The image features are dense features of the input medical image providing contextual information over the entire input medical image. In one example, as shown in workflow 100 of FIG. 1, the image features may be dense features 108 extracted by CNN (convolutional neural network) 106 from input image 102. CNN 106 is an encoder network, such as, e.g., an autoencoder or any other suitable encoding network. CNN 106 receives as input the input medical image and generates as output dense features 108. Dense features 108 are latent features or embeddings of the input medical image.

The region features and region coordinates respectively identify the region and coordinates of anatomical objects of interest identified in the input medical image. In one example, as shown in workflow 100 of FIG. 1, the region features and region coordinates respectively are region features 118 and region coordinates 120 of regions of anatomical objects of interest identified in results 112 by object detector network 110 from input image 102. Object detector network 110 may be implemented according to any suitable machine learning based architecture (e.g., Faster-RCNN (region-based CNN) or any well-known architecture) for performing a target object detection task. The region features and region coordinates are features and coordinates of regions (e.g., bounding boxes) localizing the anatomical objects of interest identified in the input medical image. The region features help the trained machine learning based model (utilized at step 206 of FIG. 2) emphasize the most important regions of the input medical image, which include relevant information about the anatomical objects of interest. The region coordinates provide additional information about the localization of the anatomical objects of interest. The region features and region coordinates are provided for each region of the anatomical objects of interest identified in the input medical image by the object detector network.

The textual labels are text-based labels identifying the anatomical objects of interest identified in the input medical image by the object detector network. For example, as shown in workflow 100 of FIG. 1, the textual labels are represented as token embeddings 116 of labels 114 identified in results 112 by object detector network 110 from input image 102. Token embeddings 116 may be generated by encoding labels 114 using a machine learning based language model (e.g., BERT (bidirectional encoder representations from transformers)). The textual labels help the trained machine learning based model (utilized at step 206 of FIG. 2) generate text sequences with a higher degree of precision by enumerating the labels or names that must be mentioned while generating the text.

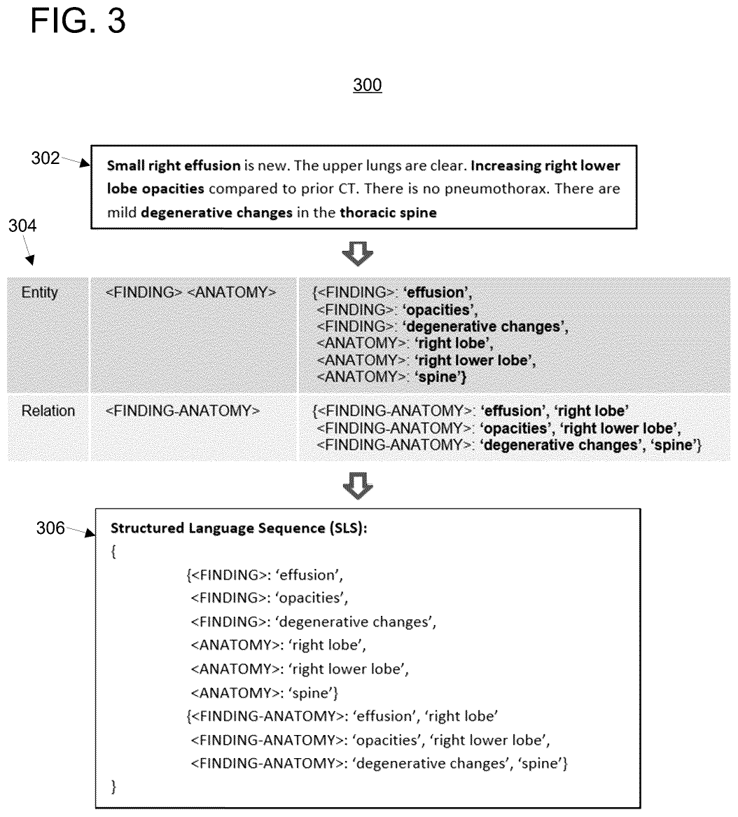

In one embodiment, the features extracted from the input medical text (including the text of the input medical image/text pair) may comprise any features representing the input medical text. In one example, as shown in workflow 100 of FIG. 1, the features are token embeddings 126 representing input text 104. Information extraction module 122 first extracts a structured representation (e.g., an SLS (structured language sequence) representation 124) from input text 104. SLS representation 124 is a compact representation of input text 104. SLS representation 124 is then encoded to token embeddings 126 using a machine learning based language model (e.g., BERT). Token embeddings 126 representing input text 104 help the trained machine learning based model (utilized at step 206 of FIG. 2) to concentrate on this data. This approach simplifies the text-to-image generation task by removing redundant information from input text 104 and specifying only the anatomical objects of interest (e.g., abnormalities) and their location (e.g., the affected anatomical structure) as they should appear in the generated image. Extraction of SLS representation 124 from input text 104 is further described below with respect to FIG. 3.

FIG. 3 shows a workflow 300 for extracting an SLS representation from input text, in accordance with one or more embodiments. In one example, input text 302 and SLS representation 306 of FIG. 3 is input text 104 and SLS representation 124 of FIG. 1. As shown in workflow 300, extracted information 304 is extracted from input text 302. Extracted information 304 comprises entities, such as, e.g., findings <FINDING> and anatomy <ANATOMY>, along with their relationships <FINDING-ANATOMY>. Extracted information 304 is then represented as an SLS representation 306.

Referring back to FIG. 2, at step 206, one of A) synthetic medical text, B) a synthetic medical image, or C) a synthetic medical image/text pair is generated for the received one of 1) the input medical image, 2) the input medical text, or 3) the input medical image/text pair respectively based on the extracted features and using a trained machine learning based model. Accordingly, where the input medical image is received as input, a corresponding synthetic medical text is generated based on features extracted from the input medical image, thereby forming a text/image pair comprising the input medical image and the synthetic medical text. Where the input medical text is received as input, a corresponding synthetic medical image is generated based on features extracted from the input medical text, thereby forming a text/image pair comprising the synthetic medical image and the input medical text. Where the input medical image/text pair is received as input, a corresponding synthetic medical image/text pair is generated based on features extracted from the image and the text of the input medical image/text pair. The synthetic medical image/text pair is a different variation of the input medical image/text pair.

The trained machine learning based model may be implemented according to any suitable machine learning based architecture. In one embodiment, the trained machine learning based model is a multimodal transformer network. In one example, as shown in workflow 100 of FIG. 1, the trained multimodal transformer network is multimodal transformer 136. Multimodal transformer 136 receives as input features extracted from the input medical image (e.g., dense features 108, tokens embeddings 116, region features 118, and/or region coordinates 120) and/or features extracted from the input medical text (e.g., token embeddings 126) and generates as output synthetic text 128 and/or synthetic image features 130. To generate synthetic text 128, multimodal transformer 136 continuously predicts text tokens based on the extracted features. However, to generate synthetic image 134, an image generator network 132 is utilized to convert synthetic image features 130 to synthetic image 134. Image generator network 132 may be a Stable Diffusion model, a GAN (generative adversarial network), or any other suitable machine learning based model.

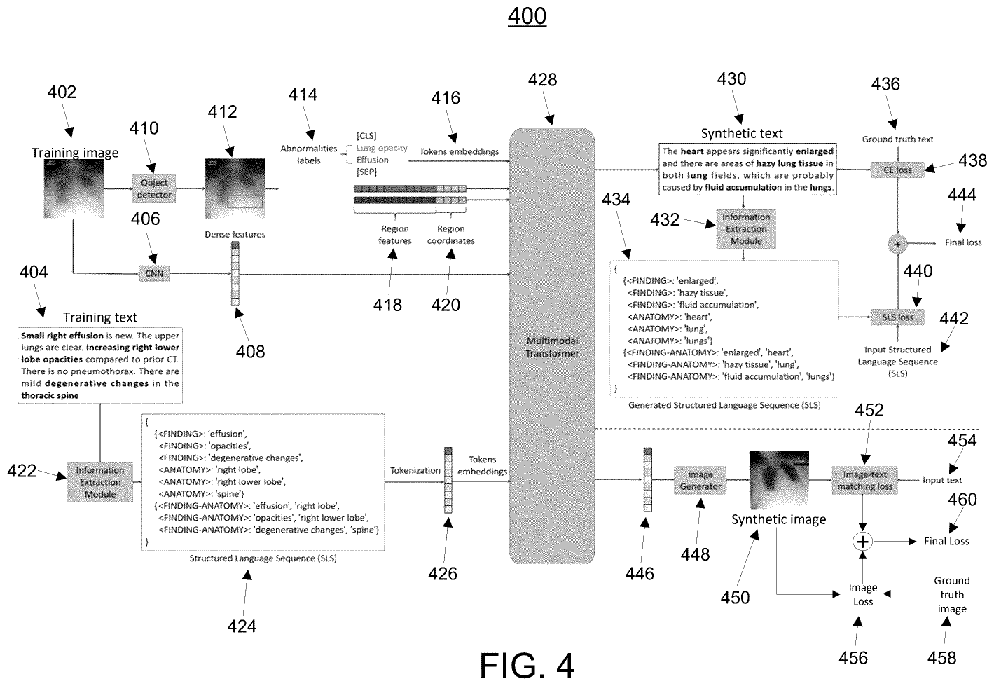

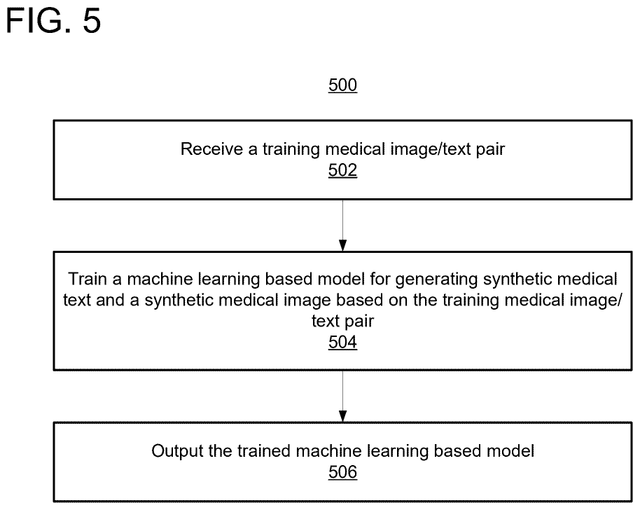

The trained machine learning based model is trained during a prior offline or training stage. For example, the trained machine learning based model may be trained according to workflow 400 of FIG. 4 or method 500 of FIG. 5, as explained in detail below. Once trained, the trained machine learning based model is applied during an online or inference stage, e.g., as multimodal transformer 136 of FIG. 1 or at step 206 of FIG. 2, to generate synthetic medical data.

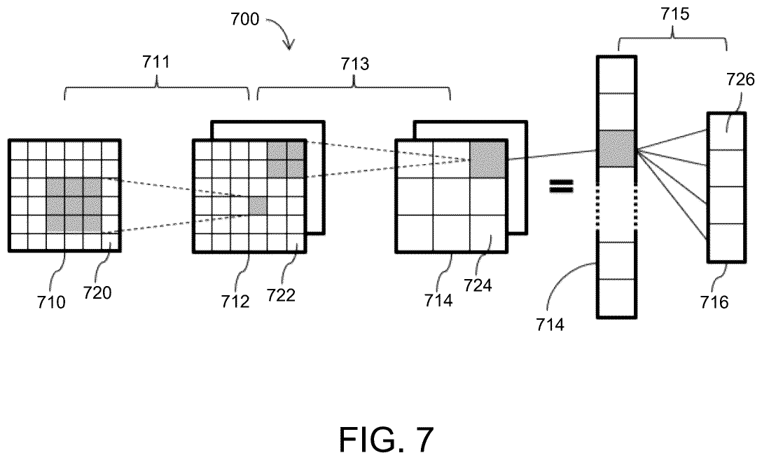

At step 208 of FIG. 2, the generated one of A) the synthetic medical text, B) the synthetic medical image, or C) the synthetic medical image/text pair is output. For example, the generated one of A) the synthetic medical text, B) the synthetic medical image, or C) the synthetic medical image/text pair can be output by displaying the generated one of A) the synthetic medical text, B) the synthetic medical image, or C) the synthetic medical image/text pair on a display device of a computer system (e.g., I/O 708 of computer 702 of FIG. 7), storing the generated one of A) the synthetic medical text, B) the synthetic medical image, or C) the synthetic medical image/text pair on a memory or storage of a computer system (e.g., memory 1010 and/or storage 1012 of computer 1002 of FIG. 10), or by transmitting the generated one of A) the synthetic medical text, B) the synthetic medical image, or C) the synthetic medical image/text pair to a remote computer system (e.g., computer 1002 of FIG. 10).

In one embodiment, the generated one of A) the synthetic medical text, B) the synthetic medical image, or C) the synthetic medical image/text pair may be utilized for training a machine learning based model for performing a medical analysis task. For example, the input medical image and the corresponding synthetic medical text may be utilized as a pair for training a machine learning based model, the input medical text and the corresponding synthetic medical image may be utilized as a pair for training a machine learning based model, and/or the synthetic medical image/text pair may be utilized as a pair for training a machine learning based model.

FIG. 4 shows a workflow 400 for training a machine learning based model for generating synthetic medical data, in accordance with one or more embodiments. FIG. 5 shows a method 500 for training a machine learning based model for generating synthetic medical data, in accordance with one or more embodiments. The steps of method 500 may be performed by one or more suitable computing devices, such as, e.g., computer 1002 of FIG. 10. FIG. 4 and FIG. 5 will be described together. The steps/operations of workflow 400 and method 500 are performed during a prior offline or training stage for training the machine learning based model. Once trained, the trained machine learning based model is applied during an online or inference stage, e.g., as multimodal transformer 136 of FIG. 1 or at step 206 of FIG. 2, to generate synthetic medical data.

At step 502 of FIG. 5, a training medical image/text pair is received. The training medical image/text pair comprises a training medical image and training medical text. In one example, as shown in workflow 400 of FIG. 4, the training medical image is training image 402 and the training medical text is training text 404. The training medical image and the training medical text are paired such that the image depicts, and the text describes, a same medical condition(s).

The training medical image (including the image in the training medical image/text pair) may depict any anatomical object. The training medical image may be of any suitable modality, such as, e.g., CT, MRI, US, x-ray, or any other medical imaging modality or combinations of medical imaging modalities. The training medical image may be a 2D image and/or a 3D volume.

The training medical text (including the text of the training medical image/text pair) may comprise any textual medical information. In one embodiment, the training medical text is in an arbitrary, unstructured format in natural language. The training medical text may be received as text, voice, or in any other suitable form.

The training medical image/text pair can be received by, for example, receiving the training medical image/text pair from a user interacting with a computer (e.g., via I/O 1008 of computer 1002 of FIG. 10), by loading the training medical image/text pair from a storage or memory of a computer system (e.g., memory 1010 and/or storage 1012 of computer 1002 of FIG. 10), and/or by loading the training medical image/text pair from a remote computer system (e.g., computer 1002 of FIG. 10). In another example, the training medical image may be received directly from an image acquisition device (e.g., image acquisition device 1014 of FIG. 10) as the medical image is acquired.

At step 504 of FIG. 5, a machine learning based model is trained for generating synthetic medical text and a synthetic medical image based on the training medical image/text pair. The machine learning based model may be implemented according to any suitable machine learning based architecture. In one embodiment, the machine learning based model is a multimodal transformer network. In one example, as shown in workflow 400 of FIG. 4, the multimodal transformer network is multimodal transformer 428.

In one embodiment, multimodal transformer 428 is trained using ground truth image/text pairs according to a gradual self-supervised learning approach having two training stages: 1) training multimodal transformer 428 using the training image/text pair; and 2) replacing, in turn, the training medical image and the training medical text from the training image/text pair with a modified (e.g., noisy) version of the training medical image or text and training multimodal transformer 428 to generate the corresponding synthetic medical text and synthetic medical image respectively. The modified input behaves as a prompt to indicate to multimodal transformer 428 what task to perform. As such, if a modified image replaces the training medical image, multimodal transformer 428 generates the synthetic medical image for the training medical text. If modified text replaces the training medical text, multimodal transformer 428 generates the synthetic medical text for the training medical image. The ground truth text and image are only used for back-propagation during the second stage.

To train multimodal transformer 428, features are first extracted from training image 402 and training text 404. Training image 402 may be the training medical image of the training image/text pair or the modified image. Training text 404 may be the training medical text of the training image/text pair or the modified text. The features extracted from training image 402 may comprise one or more extracted features. In one embodiment, the features extracted from the training image 402 comprises one or more of image features, region features, region coordinates, and textual labels. In one example, as shown in workflow 400 of FIG. 4, the image features may be dense features 408 extracted by CNN 406 (e.g., an autoencoder) from training image 402. The region features and region coordinates respectively may be region features 418 and region coordinates 420 identified in results 412 of object detector network 410 from training image 402. The textual labels may be represented as token embeddings 416 of labels 414 identified in results 412 by object detector network 410 from training image 402. The features extracted from the training text 404 may comprise any features representing training text 404. In one example, as shown in workflow 400 of FIG. 4, the features are token embeddings 426 representing training text 404. Tokens embeddings 426 are generated by first extracting a structured representation (e.g., an SLS representation 424) from training text 404 by information extraction module 422 and encoding SLS representation 424 to tokens embeddings 426.

Multimodal transformer 428 receives as input features extracted from training image 402 (e.g., dense features 408, tokens embeddings 416, region features 418, and/or region coordinates 420) and features extracted from training text 404 (e.g., tokens embeddings 426) and generates as output synthetic text 430 and synthetic image features 446. Multimodal transformer 428 learns a contextualized representation of the features in a joint embedding space via a multi-head attention mechanism. To promote joint representation learning, a self-supervised objective is applied that involves reconstructing training text 404 and training image 402. This approach encourages the multimodal transformer 428 to learn a shared representation that captures important features of both the text and image information, thereby facilitating a more robust and integrated understanding of the data. By injecting structured knowledge information in the training, the alignment of the image and text pairs and the reasoning capacity of multimodal transformer 428 are improved.

Multimodal transformer 428 is trained for the image-to-text generation task using CE (cross-entropy) loss 438 and SLS loss 440. CE loss 438 is utilized in a “teacher-forcing”manner such that the synthetic text 430 is compared with ground truth text 436 (i.e., training text 404) in each step of training. SLS loss 440 is computed by comparing SLS representation 434 extracted from synthetic text 430 by information extraction module 432 (e.g., according to FIG. 3) with input SLS representation 442 extracted from ground truth text 436 by information extraction module 432. Information extraction module 432 applies the same information extraction algorithm to both synthetic text 430 and ground truth text 436 to extract SLS representation 434 and input SLS representation 442. Since information may be conveyed using various phrases and terminology, the relation-extraction loss using SLS loss 440 may be advantageous since it examines whether key concepts are present in both the synthetic text 430 and ground truth text 436. CE loss 438 and SLS loss 440 are combined to generate final loss 444.

Multimodal transformer 428 is trained for the text-to-image generation task using image-text matching loss 452 and image loss 456. Image-text matching loss 452 compares synthetic image 450 generated from synthetic image features 446 by image generator network 448 with input text 454 (i.e., training text 404). Image loss 456 compares synthetic image 450 with ground truth image 458 (i.e., training image 402). Image-text matching loss 452 and image loss 456 are combined to generate final loss 460.

In training multimodal transformer 428: A) when the input comprises a ground truth training medical image/text pair, multimodal transformer 428 is trained with CE loss 438 and SLS loss 440 and image-text matching loss 452 and image loss 456, as shown in FIG. 4; B) when the input comprises a ground truth training medical image and a modified version of the ground truth training medical text, the parts/layers of multimodal transformer 428 responsible for image generation are frozen (i.e., the weights of image-text matching loss 452 and image loss 456 are set to zero); C) when the input comprises a modified version of the ground truth training medical image and the ground truth training medical text, the parts/layers of multimodal transformer 428 responsible for text generation are frozen (i.e., the weights of CE loss 438 and SLS loss 440 are set to zero); and D) when the input comprises a controllable modification of the ground truth training medical image and the ground truth training medical text, much finer weights at the level of text tokens and image patches are designed and used at the computation of the losses (i.e., CE loss 438 and SLS loss 440 for the image-to-text generation task and image-text matching loss 452 and image loss 456 for the text-to-image generation task). This approach allows multimodal transformer 428 to be used, during the inference stage, on datasets comprising both image/text pairs as well as datasets comprising singular modalities (i.e., only images or only text).

In one embodiment, training of multimodal transformer 428 may be further extended to improve performance on the text-to-image task by utilizing datasets comprising only text. In this embodiment, image loss 456 is discarded (since there is no image available) and final loss 460 will be image-text matching loss 452.

In one embodiment, training of multimodal transformer 428 may be further performed based on imaging metadata, such as, e.g., references to abnormalities or reasons for the imaging. The imaging metadata can be converted into ground truth SLS and used as input SLS 442 for the computation of SLS loss 440. In this embodiment, CE loss 438 is discarded and final loss 444 will be SLS loss 440.

At step 506 of FIG. 5, the trained machine learning based model is output. For example, the trained machine learning based model can be output by storing the trained machine learning based model on a memory or storage of a computer system (e.g., memory 1010 and/or storage 1012 of computer 1002 of FIG. 10) or by transmitting the trained machine learning based model to a remote computer system (e.g., computer 1002 of FIG. 10).

Advantageously, embodiments described herein provide for the generation of multimodal synthetic medical data. As there is a shortage of multimodal medical data due to the difficulty to obtain such multimodal medical data, embodiments described herein can address this shortage. Further, embodiments described herein provide for a multimodal transformer network trained using self-supervised learning, where the transformer network is exposed to multimodal inputs in a gradual manner, i.e., one of images or text of real image/text pair inputs are exchanged with noisy variations of the same multimodal input pair. One advantage of this approach is that the transformer network will be able to generate more qualitative images and texts by first learning a contextualized representation for both images and texts, and then learning to solve the harder tasks of generating only one modality when the other is missing. In addition, the multimodal transformer network is directed by creating knowledge-induced input representations to focus on the most important information in images and texts (e.g., region features offer relevant information about existing abnormalities, region coordinates introduce additional information about the localization of abnormalities in the image, predicted textual labels for each region and SLS for the input text reduces the complexity of encoding/decoding.

Embodiments described herein are described with respect to the claimed systems as well as with respect to the claimed methods. Features, advantages or alternative embodiments herein can be assigned to the other claimed objects and vice versa. In other words, claims and embodiments for the systems can be improved with features described or claimed in the context of the respective methods. In this case, the functional features of the method are implemented by physical units of the system.

Furthermore, certain embodiments described herein are described with respect to methods and systems utilizing trained machine learning models (e.g., FIGS. 1-2), as well as with respect to methods and systems for training machine learning models (e.g., FIGS. 4-5). Features, advantages or alternative embodiments herein can be assigned to the other claimed objects and vice versa. In other words, claims and embodiments for training machine learning models can be improved with features described or claimed in the context of utilizing trained machine learning models, and vice versa. In particular, datasets used in the methods and systems for utilizing trained machine learning models can have the same properties and features as the corresponding datasets used in the methods and systems for providing trained machine learning models, and the trained machine learning models provided by the respective methods and systems can be used in the methods and systems for utilizing the trained machine learning models.

In general, a trained machine learning model mimics cognitive functions that humans associate with other human minds. In particular, by training based on training data the machine learning model is able to adapt to new circumstances and to detect and extrapolate patterns. Another term for “trained machine learning model” is “trained function.”

In general, parameters of a machine learning model can be adapted by means of training. In particular, supervised training, semi-supervised training, unsupervised training, reinforcement learning and/or active learning can be used. Furthermore, representation learning (an alternative term is “feature learning”) can be used. In particular, the parameters of the machine learning models can be adapted iteratively by several steps of training. In particular, within the training a certain cost function can be minimized. In particular, within the training of a neural network the backpropagation algorithm can be used.

In particular, a machine learning model, such as, e.g., CNN 106, object detector network 110, multimodal transformer 136, or image generator network 132 of FIG. 1, the trained machine learning based model utilized at step 206 of FIG. 2, CNN 406, object detector network 410, multimodal transformer 428, or image generator network 448 of FIG. 4, or the machine learning based model utilized at step 504 of FIG. 5, can comprise, for example, a neural network. In particular, a neural network can be, e.g., a deep neural network, a convolutional neural network or a convolutional deep neural network. Furthermore, a neural network can be, e.g., an adversarial network, a deep adversarial network and/or a generative adversarial network.

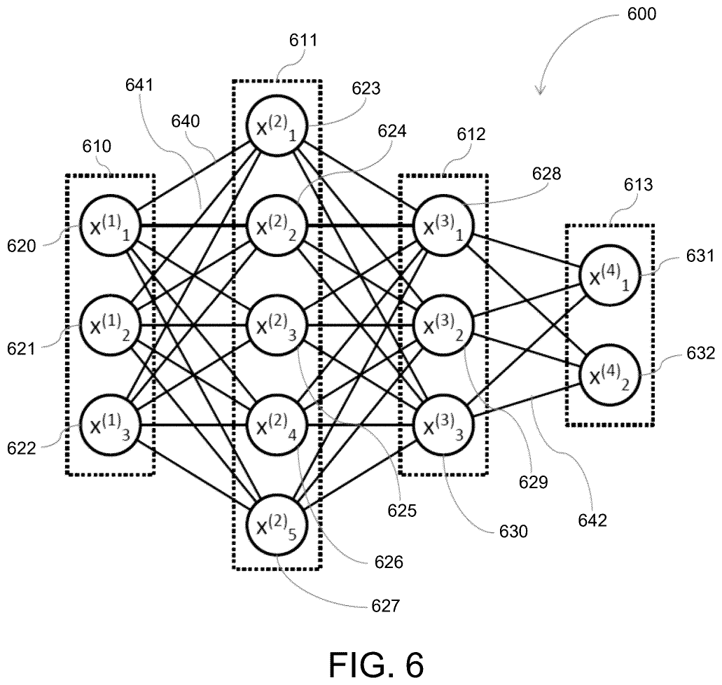

FIG. 6 shows an embodiment of an artificial neural network 600 that may be used to implement one or more machine learning models described herein. Alternative terms for “artificial neural network” are “neural network”, “artificial neural net” or “neural net”.

The artificial neural network 600 comprises nodes 620, . . . , 632 and edges 640, 642, wherein each edge 640, . . . , 642 is a directed connection from a first node 620, 632 to a second node 620, . . . , 632. In general, the first node 620, . . . , 632 and the second node 620, . . . , 632 are different nodes 620, . . . , 632, it is also possible that the first node 620, . . . , 632 and the second node 620, . . . , 632 are identical. For example, in FIG. 6 the edge 640 is a directed connection from the node 620 to the node 623, and the edge 642 is a directed connection from the node 630 to the node 632. An edge 640, . . . , 642 from a first node 620, . . . , 632 to a second node 620, . . . , 632 is also denoted as “ingoing edge” for the second node 620, . . . , 632 and as “outgoing edge” for the first node 620, . . . 632.

In this embodiment, the nodes 620, . . . , 632 of the artificial neural network 600 can be arranged in layers 610, . . . , 613, wherein the layers can comprise an intrinsic order introduced by the edges 640, . . . , 642 between the nodes 620, . . . , 632. In particular, edges 640, . . . , 642 can exist only between neighboring layers of nodes. In the displayed embodiment, there is an input layer 610 comprising only nodes 620, . . . , 622 without an incoming edge, an output layer 613 comprising only nodes 631, 632 without outgoing edges, and hidden layers 611, 612 in-between the input layer 610 and the output layer 613. In general, the number of hidden layers 611, 612 can be chosen arbitrarily. The number of nodes 620, . . . , 622 within the input layer 610 usually relates to the number of input values of the neural network, and the number of nodes 631, 632 within the output layer 613 usually relates to the number of output values of the neural network.

In particular, a (real) number can be assigned as a value to every node 620, . . . , 632 of the neural network 600. Here, x⁽ⁿ⁾i denotes the value of the i-th node 620, . . . , 632 of the n-th layer 610, . . . , 613. The values of the nodes 620, . . . , 622 of the input layer 610 are equivalent to the input values of the neural network 600, the values of the nodes 631, 632 of the output layer 613 are equivalent to the output value of the neural network 600. Furthermore, each edge 640, . . . , 642 can comprise a weight being a real number, in particular, the weight is a real number within the interval [−1, 1] or within the interval [0, 1]. Here, w^{(m,n)}i,j denotes the weight of the edge between the i-th node 620, . . . , 632 of the m-th layer 610, . . . , 613 and the j-th node 620, . . . , 632 of the n-th layer 610, . . . , 613. Furthermore, the abbreviation w⁽ⁿ⁾i,j is defined for the weight w^{(n,n+1)}i,j.

In particular, to calculate the output values of the neural network 600, the input values are propagated through the neural network. In particular, the values of the nodes 620, . . . , 632 of the (n+1)-th layer 610, . . . , 613 can be calculated based on the values of the nodes 620, . . . , 632 of the n-th layer 610, . . . , 613 by

$${x}^{{( n + 1 )}_{j}} = f ( {\sum }_{i} {x}^{{( n )}_{i}} \cdot {w}^{{( n )}_{i , j}} ) .$$

Herein, the function f is a transfer function (another term is “activation function”). Known transfer functions are step functions, sigmoid function (e.g., the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 610 are given by the input of the neural network 600, wherein values of the first hidden layer 611 can be calculated based on the values of the input layer 610 of the neural network, wherein values of the second hidden layer 612 can be calculated based on the values of the first hidden layer 611, etc.

In order to set the values w^{(m,n)i,j} for the edges, the neural network 600 has to be trained using training data. In particular, training data comprises training input data and training output data (denoted as tᵢ). For a training step, the neural network 600 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 600 (backpropagation algorithm). In particular, the weights are changed according to

$${w}^{{′}^{{( n )}_{i , j}}} = {w}^{{( n )}_{i , j}} - γ \cdot {δ}^{{( n )}_{j}} \cdot {x}^{{( n )}_{i}}$$

wherein γ is a learning rate, and the numbers δ⁽ⁿ⁾ⱼ can be recursively calculated as

$${δ}^{{( n )}_{j}} = ( {\sum }_{k} {δ}^{{( n + 1 )}_{k}} \cdot {w}^{{( n + 1 )}_{j , k}} ) \cdot {f}^{′} ( {\sum }_{i} {x}^{{( n )}_{i}} \cdot {w}^{{( n )}_{i , j}} )$$

based on δ⁽ⁿ⁺¹⁾ⱼ, if the (n+1)-th layer is not the output layer, and

$${δ}^{{( n )}_{j}} = ( {x}^{{( n + 1 )}_{j}} - {t}^{{( n + 1 )}_{j}} ) \cdot {f}^{′} ( {x}^{{( n )}_{i}} \cdot {w}^{{( n )}_{i , j}} )$$

if the (n+1)-th layer is the output layer 613, wherein f′ is the first derivative of the activation function, and t⁽ⁿ⁺¹⁾ⱼ is the comparison training value for the j-th node of the output layer 613.

A convolutional neural network is a neural network that uses a convolution operation instead general matrix multiplication in at least one of its layers (so-called “convolutional layer”). In particular, a convolutional layer performs a dot product of one or more convolution kernels with the convolutional layer's input data/image, wherein the entries of the one or more convolution kernel are the parameters or weights that are adapted by training. In particular, one can use the Frobenius inner product and the ReLU activation function. A convolutional neural network can comprise additional layers, e.g., pooling layers, fully connected layers, and normalization layers.

By using convolutional neural networks input images can be processed in a very efficient way, because a convolution operation based on different kernels can extract various image features, so that by adapting the weights of the convolution kernel the relevant image features can be found during training. Furthermore, based on the weight-sharing in the convolutional kernels less parameters need to be trained, which prevents overfitting in the training phase and allows to have faster training or more layers in the network, improving the performance of the network.

FIG. 7 shows an embodiment of a convolutional neural network 700 that may be used to implement one or more machine learning models described herein. In the displayed embodiment, the convolutional neural network comprises 700 an input node layer 710, a convolutional layer 711, a pooling layer 713, a fully connected layer 714 and an output node layer 716, as well as hidden node layers 712, 714. Alternatively, the convolutional neural network 700 can comprise several convolutional layers 711, several pooling layers 713 and several fully connected layers 715, as well as other types of layers. The order of the layers can be chosen arbitrarily, usually fully connected layers 715 are used as the last layers before the output layer 716.

In particular, within a convolutional neural network 700 nodes 720, 722, 724 of a node layer 710, 712, 714 can be considered to be arranged as a d-dimensional matrix or as a d-dimensional image. In particular, in the two-dimensional case the value of the node 720, 722, 724 indexed with i and j in the n-th node layer 710, 712, 714 can be denoted as x(n)[i, j]. However, the arrangement of the nodes 720, 722, 724 of one node layer 710, 712, 714 does not have an effect on the calculations executed within the convolutional neural network 700 as such, since these are given solely by the structure and the weights of the edges.

A convolutional layer 711 is a connection layer between an anterior node layer 710 (with node values x(n−1)) and a posterior node layer 712 (with node values x(n)). In particular, a convolutional layer 711 is characterized by the structure and the weights of the incoming edges forming a convolution operation based on a certain number of kernels. In particular, the structure and the weights of the edges of the convolutional layer 711 are chosen such that the values x(n) of the nodes 722 of the posterior node layer 712 are calculated as a convolution x(n)=K*x(n−1) based on the values x(n−1) of the nodes 720 anterior node layer 710, where the convolution * is defined in the two-dimensional case as

$${x}_{k}^{( n )} [ i , j ] = ( K * {x}^{( n - 1 )} ) [ i , j ] = {\sum }_{{i}^{′}} {\sum }_{{j}^{′}} K [ {i}^{′} , {j}^{′} ] \cdot {x}^{( n - 1 )} [ i - {i}^{′} , j - {j}^{′} ] .$$

Here the kernel K is a d-dimensional matrix (in this embodiment, a two-dimensional matrix), which is usually small compared to the number of nodes 720, 722 (e.g., a 3×3 matrix, or a 5×5 matrix). In particular, this implies that the weights of the edges in the convolution layer 711 are not independent, but chosen such that they produce said convolution equation. In particular, for a kernel being a 3×3 matrix, there are only 9 independent weights (each entry of the kernel matrix corresponding to one independent weight), irrespectively of the number of nodes 720, 722 in the anterior node layer 710 and the posterior node layer 712.

In general, convolutional neural networks 700 use node layers 710, 712, 714 with a plurality of channels, in particular, due to the use of a plurality of kernels in convolutional layers 711. In those cases, the node layers can be considered as (d+1)-dimensional matrices (the first dimension indexing the channels). The action of a convolutional layer 711 is then a two-dimensional example defined as

$${x}^{{( n )}_{b}} [ i , j ] = {\sum }_{a} {K}_{a , b} * {x}^{{( n - 1 )}_{a}} [ i , j ] = {\sum }_{a} {\sum }_{{i}^{′}} {\sum }_{{j}^{′}} {K}_{a , b} [ {i}^{′} , {j}^{′} ] \cdot {x}^{{( n - 1 )}_{a}} [ i - {i}^{′} , j - {j}^{′} ]$$

where x^{(n-1)a} corresponds to the a-th channel of the anterior node layer 710, x⁽ⁿ⁾b corresponds to the b-th channel of the posterior node layer 712 and K_{a,b} corresponds to one of the kernels. If a convolutional layer 711 acts on an anterior node layer 710 with A channels and outputs a posterior node layer 712 with B channels, there are A-B independent d-dimensional kernels K_{a,b}.

In general, in convolutional neural networks 700 activation functions are used. In this embodiment re ReLU (acronym for “Rectified Linear Units”) is used, with R(z)=max(0, z), so that the action of the convolutional layer 711 in the two-dimensional example is

$${x}^{{( n )}_{b}} [ i , j ] = R ( {\sum }_{a} ( {K}_{a , b} * {x}^{{( n - 1 )}_{a}} ) [ i , j ] ) = R ( {\sum }_{a} {\sum }_{{i}^{′}} {\sum }_{{j}^{′}} {K}_{a , b} [ {i}^{′} , {j}^{′} ] \cdot {x}^{{( n - 1 )}_{a}} [ i - {i}^{′} , j - {j}^{′} ] )$$

It is also possible to use other activation functions, e.g., ELU (acronym for “Exponential Linear Unit”), LeakyReLU, Sigmoid, Tanh or Softmax.

In the displayed embodiment, the input layer 710 comprises 36 nodes 720, arranged as a two-dimensional 6×6 matrix. The first hidden node layer 712 comprises 72 nodes 722, arranged as two two-dimensional 6×6 matrices, each of the two matrices being the result of a convolution of the values of the input layer with a 3×3 kernel within the convolutional layer 711. Equivalently, the nodes 722 of the first hidden node layer 712 can be interpreted as arranged as a three-dimensional 2×6×6 matrix, wherein the first dimension correspond to the channel dimension.

The advantage of using convolutional layers 711 is that spatially local correlation of the input data can exploited by enforcing a local connectivity pattern between nodes of adjacent layers, in particular by each node being connected to only a small region of the nodes of the preceding layer.

A pooling layer 713 is a connection layer between an anterior node layer 712 (with node values x(n−1)) and a posterior node layer 714 (with node values x(n)). In particular, a pooling layer 713 can be characterized by the structure and the weights of the edges and the activation function forming a pooling operation based on a non-linear pooling function f. For example, in the two-dimensional case the values x(n) of the nodes 724 of the posterior node layer 714 can be calculated based on the values x(n−1) of the nodes 722 of the anterior node layer 712 as

$${x}^{{( n )}_{b}} [ i , j ] = f ( {x}^{( n - 1 )} [ {id}_{1} , {jd}_{2} ] , … , {x}^{{( n - 1 )}_{b}} [ ( i + 1 ) {d}_{1} - 1 , ( j + 1 ) {d}_{2} - 1 ] )$$

In other words, by using a pooling layer 713 the number of nodes 722, 724 can be reduced, by re-placing a number d1·d2 of neighboring nodes 722 in the anterior node layer 712 with a single node 722 in the posterior node layer 714 being calculated as a function of the values of said number of neighboring nodes. In particular, the pooling function f can be the max-function, the average or the L2-Norm. In particular, for a pooling layer 713 the weights of the incoming edges are fixed and are not modified by training.

The advantage of using a pooling layer 713 is that the number of nodes 722, 724 and the number of parameters is reduced. This leads to the amount of computation in the network being reduced and to a control of overfitting.

In the displayed embodiment, the pooling layer 713 is a max-pooling layer, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

In general, the last layers of a convolutional neural network 700 are fully connected layers 715. A fully connected layer 715 is a connection layer between an anterior node layer 714 and a posterior node layer 716. A fully connected layer 713 can be characterized by the fact that a majority, in particular, all edges between nodes 714 of the anterior node layer 714 and the nodes 716 of the posterior node layer are present, and wherein the weight of each of these edges can be adjusted individually.

In this embodiment, the nodes 724 of the anterior node layer 714 of the fully connected layer 715 are displayed both as two-dimensional matrices, and additionally as non-related nodes (indicated as a line of nodes, wherein the number of nodes was reduced for a better presentability). This operation is also denoted as “flattening”. In this embodiment, the number of nodes 726 in the posterior node layer 716 of the fully connected layer 715 smaller than the number of nodes 724 in the anterior node layer 714.

Alternatively, the number of nodes 726 can be equal or larger.

Furthermore, in this embodiment the Softmax activation function is used within the fully connected layer 715. By applying the Softmax function, the sum the values of all nodes 726 of the output layer 716 is 1, and all values of all nodes 726 of the output layer 716 are real numbers between 0 and 1. In particular, if using the convolutional neural network 700 for categorizing input data, the values of the output layer 716 can be interpreted as the probability of the input data falling into one of the different categories.

In particular, convolutional neural networks 700 can be trained based on the backpropagation algorithm. For preventing overfitting, methods of regularization can be used, e.g., dropout of nodes 720, . . . , 724, stochastic pooling, use of artificial data, weight decay based on the L1 or the L2 norm, or max norm constraints.

According to an aspect, the machine learning model may comprise one or more residual networks (ResNet). In particular, a ResNet is an artificial neural network comprising at least one jump or skip connection used to jump over at least one layer of the artificial neural network. In particular, a ResNet may be a convolutional neural network comprising one or more skip connections respectively skipping one or more convolutional layers. According to some examples, the ResNets may be represented as m-layer ResNets, where m is the number of layers in the corresponding architecture and, according to some examples, may take values of 34, 50, 101, or 152. According to some examples, such an m-layer ResNet may respectively comprise (m−2)/2 skip connections.

A skip connection may be seen as a bypass which directly feeds the output of one preceding layer over one or more bypassed layers to a layer succeeding the one or more bypassed layers. Instead of having to directly fit a desired mapping, the bypassed layers would then have to fit a residual mapping “balancing” the directly fed output.

A generative adversarial model (GA model) or generative adversarial network (GAN) comprises a generative function and a discriminative function, wherein the generative function creates synthetic data, and the discriminative function distinguishes between synthetic and real data. By training the generative function and/or the discriminative function on the one hand the generative function is configured to create synthetic data which is incorrectly classified by the discriminative function as real, on the other hand the discriminative function is configured to distinguish between real data and synthetic data generated by the generative function. In the notion of game theory, a generative adversarial model can be interpreted as a zero-sum game. The training of the generative function and/or of the discriminative function is based, in particular, on the minimization of a cost function.

By using a GA model, based on a set of training data synthetic data can be generated that has the same characteristics as the training data set. The training of the GA model can be based on data not being annotated (unsupervised learning), so that there is low effort in training a GA model.

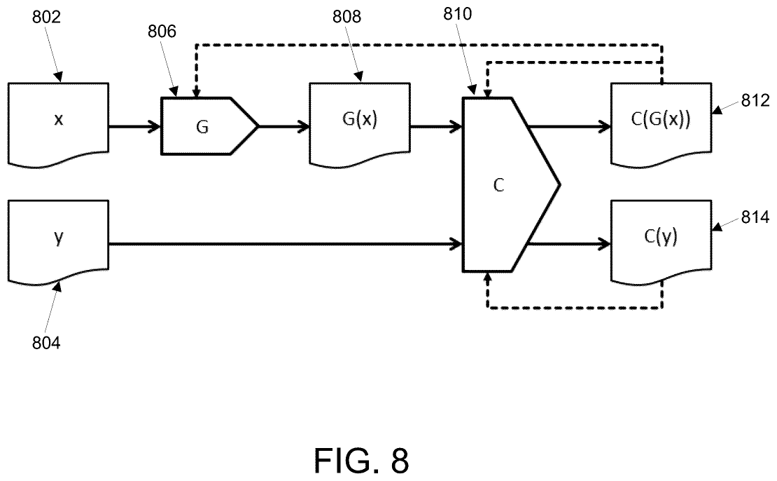

FIG. 8 shows a data flow diagram according to an embodiment for using a generative adversarial network for creating synthetic output data G(x) 808 based on input data x 802 that is indistinguishable from real output data y 804, in accordance with one or more embodiments.

In one embodiment, image generator network 132 of FIG. 1 or image generator network 448 of FIG. 4 may be implemented using a generative adversarial network. In this embodiment, the input data x 802 is synthetic image features 130 or 446 and the real output data y 804 is synthetic image 134 or 450 respectively. The synthetic output data G(x) 808 has the same structure as the real output data y 804, but its content is not derived from real world data.

The generative adversarial network comprises a generator function G 806 and a classifier function C 810 which are trained jointly. The task of the generator function G 806 is to provide realistic synthetic output data G(x) 808 based on input data x 802, and the task of the classifier function C 810 is to distinguish between real output data y 804 and synthetic output data G(x) 808. In particular, the output of the classifier function C 810 is a real number between 0 and 1 corresponding to the probability of the input value being real data, so that an ideal classifier function would calculate an output value of C(y) 814≈1 for real data y 804 and C(G(x)) 812≈0 for synthetic data G(x) 808.

Within the training process, parameters of the generator function G 806 are adapted so that the synthetic output data G(x) 808 has the same characteristics as real output data y 804, so that the classifier function C 810 cannot distinguish between real and synthetic data anymore. At the same time, parameters of the classifier function C 810 are adapted so that it distinguishes between real and synthetic data in the best possible way. Here, the training relies on pairs comprising input data x 802 and the corresponding real output data y 804. Within a single training step, the generator function G 806 is applied to the input data x 802 for generating synthetic output data G(x) 808. Furthermore, the classifier function C 810 is applied to the real output data y 804 for generating a first classification result C(y) 814. Additionally, the classifier function C 810 is applied to the synthetic output data G(x) 808 for generating a second classification result C(G(x)) 812.

Adapting the parameters of the generative function G 806 and the classifier function C 810 is based on minimizing a cost function by using the backpropagation algorithm, respectively. In this embodiment, the cost function K_{C} for the classifier function C 810 is K_{C} ∝−BCE(C(y), 1)−BCE(C(G(x)), 0), wherein BCE denotes the binary cross entropy defined as BCE(z, z′)=z′·log(z)+(1−z′)·log(1−z). By using this cost function, both wrongly classifying real output data as synthetic (indicated by C(y)≈0) and wrongly classifying synthetic output data as real (indicated as C(G(x)) 812≈1) increases the cost function K_{C} to be minimized. Furthermore, the cost function K_{G} for the generator function G 806 is K_{G} ∝−BCE(C(G(x)), 1)=−log (C(G(x)). By using this cost function, correctly classified synthetic output data (indicated as C(G(x)) 812≈0) leads to an increase of the cost function K_{G} to be minimized.

In particular, a recurrent machine learning model is a machine learning model whose output does not only depend on the input value and the parameters of the machine learning model adapted by the training process, but also on a hidden state vector, wherein the hidden state vector is based on previous inputs used on for the recurrent machine learning model. In particular, the recurrent machine learning model can comprise additional storage states or additional structures that incorporate time delays or comprise feedback loops.

In particular, the underlying structure of a recurrent machine learning model can be a neural network, which can be denoted as recurrent neural network. Such a recurrent neural network can be described as an artificial neural network where connections between nodes form a directed graph along a temporal sequence. In particular, a recurrent neural network can be interpreted as directed acyclic graph. In particular, the recurrent neural network can be a finite impulse recurrent neural network or an infinite impulse recurrent neural network (wherein a finite impulse network can be unrolled and replaced with a strictly feedforward neural network, and an infinite impulse network cannot be unrolled and replaced with a strictly feedforward neural network).

In particular, training a recurrent neural network can be based on the BPTT algorithm (acronym for “backpropagation through time”), on the RTRL algorithm (acronym for “real-time recurrent learning”) and/or on genetic algorithms.

By using a recurrent machine learning model input data comprising sequences of variable length can be used. In particular, this implies that the method cannot be used only for a fixed number of input datasets (and needs to be trained differently for every other number of input datasets used as input), but can be used for an arbitrary number of input datasets. This implies that the whole set of training data, independent of the number of input datasets contained in different sequences, can be used within the training, and that training data is not reduced to training data corresponding to a certain number of successive input datasets.

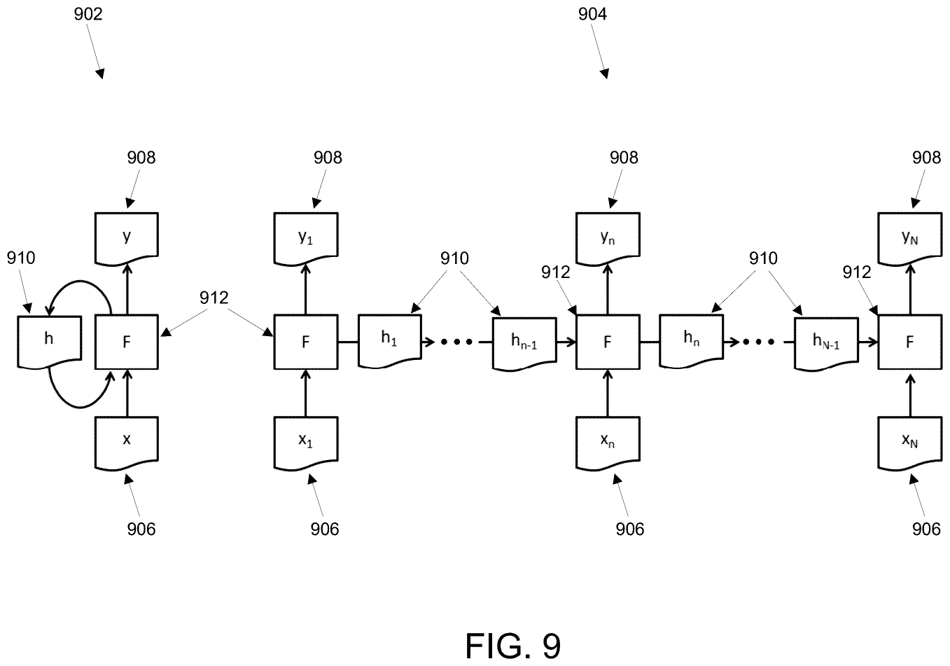

FIG. 9 shows the schematic structure of a recurrent machine learning model F, both in a recurrent representation 902 and in an unfolded representation 904, that may be used to implement one or more machine learning models described herein. The recurrent machine learning model takes as input several input datasets x, x₁, . . . , x_{N} 906 and creates a corresponding set of output datasets y, y₁, . . . , y_{N} 908. Furthermore, the output depends on a so-called hidden vector h, h₁, . . . , h_{N} 910, which implicitly comprises information about input datasets previously used as input for the recurrent machine learning model F 912. By using these hidden vectors h, h₁, . . . , h_{N} 910, a sequentiality of the input datasets can be leveraged.

In a single step of the processing, the recurrent machine learning model F 912 takes as input the hidden vector hₙ₋₁ created within the previous step and an input dataset xₙ. Within this step, the recurrent machine learning model F generates as output an updated hidden vector hₙ and an output dataset yₙ. In other words, one step of processing calculates (yₙ, hₙ)=F(xₙ, hₙ₋₁), or by splitting the recurrent machine learning model F 912 into a part F(y) calculating the output data and F(h) calculating the hidden vector, one step of processing calculates yₙ=F^{(y)}(xₙ, hₙ₋₁) and hₙ=F^{(h)}(xₙ, hₙ₋₁). For the first processing step, h₀ can be chosen randomly or filled with all entries being zero. The parameters of the recurrent machine learning model F 912 that were trained based on training datasets before do not change between the different processing steps.

In particular, the output data and the hidden vector of a processing step depend on all the previous input datasets used in the previous steps. yₙ=F^{(y)}(xₙ, F^{(h)}(xₙ₋₁, hₙ₋₂)) and hₙ=F(h)(xₙ, F^{(h)}(Xₙ₋₁, hₙ₋₂)).

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatuses, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatuses, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps or functions of the methods and workflows described herein, including one or more of the steps or functions of FIG. 1-2 or 4-5. Certain steps or functions of the methods and workflows described herein, including one or more of the steps or functions of FIG. 1-2 or 4-5, may be performed by a server or by another processor in a network-based cloud-computing system. Certain steps or functions of the methods and workflows described herein, including one or more of the steps of FIG. 1-2 or 4-5, may be performed by a client computer in a network-based cloud computing system. The steps or functions of the methods and workflows described herein, including one or more of the steps of FIG. 1-2 or 4-5, may be performed by a server and/or by a client computer in a network-based cloud computing system, in any combination.

Systems, apparatuses, and methods described herein may be implemented using a computer program product tangibly embodied in an information carrier, e.g., in a non-transitory machine-readable storage device, for execution by a programmable processor; and the method and workflow steps described herein, including one or more of the steps or functions of FIG. 1-2 or 4-5, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an example computer 1002 that may be used to implement systems, apparatuses, and methods described herein is depicted in FIG. 10. Computer 1002 includes a processor 1004 operatively coupled to a data storage device 1012 and a memory 1010. Processor 1004 controls the overall operation of computer 1002 by executing computer program instructions that define such operations. The computer program instructions may be stored in data storage device 1012, or other computer readable medium, and loaded into memory 1010 when execution of the computer program instructions is desired. Thus, the method and workflow steps or functions of FIG. 1-2 or 4-5 can be defined by the computer program instructions stored in memory 1010 and/or data storage device 1012 and controlled by processor 1004 executing the computer program instructions. For example, the computer program instructions can be implemented as computer executable code programmed by one skilled in the art to perform the method and workflow steps or functions of FIG. 1-2 or 4-5. Accordingly, by executing the computer program instructions, the processor 1004 executes the method and workflow steps or functions of FIG. 1-2 or 4-5. Computer 1002 may also include one or more network interfaces 1006 for communicating with other devices via a network. Computer 1002 may also include one or more input/output devices 1008 that enable user interaction with computer 1002 (e.g., display, keyboard, mouse, speakers, buttons, etc.).

Processor 1004 may include both general and special purpose microprocessors, and may be the sole processor or one of multiple processors of computer 1002. Processor 1004 may include one or more central processing units (CPUs), for example. Processor 1004, data storage device 1012, and/or memory 1010 may include, be supplemented by, or incorporated in, one or more application-specific integrated circuits (ASICs) and/or one or more field programmable gate arrays (FPGAs).

Data storage device 1012 and memory 1010 each include a tangible non-transitory computer readable storage medium. Data storage device 1012, and memory 1010, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1008 may include peripherals, such as a printer, scanner, display screen, etc. For example, input/output devices 1008 may include a display device such as a cathode ray tube (CRT) or liquid crystal display (LCD) monitor for displaying information to the user, a keyboard, and a pointing device such as a mouse or a trackball by which the user can provide input to computer 1002.

An image acquisition device 1014 can be connected to the computer 1002 to input image data (e.g., medical images) to the computer 1002. It is possible to implement the image acquisition device 1014 and the computer 1002 as one device. It is also possible that the image acquisition device 1014 and the computer 1002 communicate wirelessly through a network. In a possible embodiment, the computer 1002 can be located remotely with respect to the image acquisition device 1014.

Any or all of the systems, apparatuses, and methods discussed herein may be implemented using one or more computers such as computer 1002.

One skilled in the art will recognize that an implementation of an actual computer or computer system may have other structures and may contain other components as well, and that FIG. 10 is a high level representation of some of the components of such a computer for illustrative purposes.

Independent of the grammatical term usage, individuals with male, female or other gender identities are included within the term.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

The following is a list of non-limiting illustrative embodiments disclosed herein:

Illustrative embodiment 1. A computer-implemented method comprising: receiving one of 1) an input medical image, 2) input medical text, or 3) an input medical image/text pair; extracting features from the received one of 1) the input medical image, 2) the input medical text, or 3) the input medical image/text pair; generating, based on the extracted features and using a trained machine learning based model, one of A) synthetic medical text, B) a synthetic medical image, or C) a synthetic medical image/text pair for the received one of 1) the input medical image, 2) the input medical text, or 3) the input medical image/text pair respectively; and outputting the generated one of A) the synthetic medical text, B) the synthetic medical image, or C) the synthetic medical image/text pair.

Illustrative embodiment 2. The computer-implemented method according to illustrative embodiment 1, wherein: receiving one of 1) an input medical image, 2) input medical text, or 3) an input medical image/text pair comprises: receiving one of the input medical image or the input medical image/text pair; and extracting features from the received one of 1) the input medical image, 2) the input medical text, or 3) the input medical image/text pair comprises: extracting, from one of the input medical image or an image of the input medical image/text pair, one or more of dense features, tokens embeddings of textual labels of anatomical objects of interest identified in the one of the input medical image or the image of the input medical image/text pair, region features of the anatomical objects of interest, or region coordinates of the anatomical objects of interest.

Illustrative embodiment 3. The computer-implemented method according to any one of illustrative embodiments 1-2, wherein: receiving one of 1) an input medical image, 2) input medical text, or 3) an input medical image/text pair comprises: receiving one of the input medical text or the input medical image/text pair; and extracting features from the received one of 1) the input medical image, 2) the input medical text, or 3) the input medical image/text pair comprises: extracting an SLS (structured language sequence) representation from one of the input medical text or text of the input medical image/text pair; and encoding the SLS representation into token embeddings.

Illustrative embodiment 4. The computer-implemented method according to any one of illustrative embodiments 1-3, wherein generating, based on the extracted features and using a trained machine learning based model, one of A) synthetic medical text, B) a synthetic medical image, or C) a synthetic medical image/text pair for the received one of 1) the input medical image, 2) the input medical text, or 3) the input medical image/text pair respectively comprises: generating synthetic image features using the trained machine learning based model; and generating the synthetic medical image based on the synthetic image features using a machine learning based image generator network.

Illustrative embodiment 5. The computer-implemented method according to any one of illustrative embodiments 1-4, wherein the trained machine learning based model is trained by: during a first training stage, training the machine learning based model using a training image/text pair comprising a training medical image and training medical text; and during a second training stage: training the machine learning based model using 1) a modified version of the training medical image and 2) the training medical text, and training the machine learning based model using 1) a modified version of the training medical text and 2) the training medical image.

Illustrative embodiment 6. The computer-implemented method according to illustrative embodiment 5, wherein training the machine learning based model using 1) a modified version of the training medical image and 2) the training medical text comprises: generating a synthetic medical image by the machine learning based model from 1) the modified version of the training medical image and 2) the training medical text; comparing the synthetic medical image with the training medical text; and comparing the synthetic medical image with the training medical image.

Illustrative embodiment 7. The computer-implemented method according to any one of illustrative embodiments 5-6, wherein training the trained machine learning based model using 1) a modified version of the training medical text and 2) the training medical image comprises: generating synthetic medical text by the machine learning based model from 1) the modified version of the training medical text and 2) the training medical image; comparing the synthetic medical text with the training medical text; and comparing an SLS (structured language sequence) representation of the synthetic medical text with an SLS representation of the training medical text.

Illustrative embodiment 8. The computer-implemented method according to any one of illustrative embodiments 1-7, wherein the trained machine learning based model is a multimodal transformer network.

Illustrative embodiment 9. An apparatus comprising: means for receiving one of 1) an input medical image, 2) input medical text, or 3) an input medical image/text pair; means for extracting features from the received one of 1) the input medical image, 2) the input medical text, or 3) the input medical image/text pair; means for generating, based on the extracted features and using a trained machine learning based model, one of A) synthetic medical text, B) a synthetic medical image, or C) a synthetic medical image/text pair for the received one of 1) the input medical image, 2) the input medical text, or 3) the input medical image/text pair respectively; and means for outputting the generated one of A) the synthetic medical text, B) the synthetic medical image, or C) the synthetic medical image/text pair.

Illustrative embodiment 10. The apparatus according to illustrative embodiment 9, wherein: the means for receiving one of 1) an input medical image, 2) input medical text, or 3) an input medical image/text pair comprises: means for receiving one of the input medical image or the input medical image/text pair; and the means for extracting features from the received one of 1) the input medical image, 2) the input medical text, or 3) the input medical image/text pair comprises: means for extracting, from one of the input medical image or an image of the input medical image/text pair, one or more of dense features, tokens embeddings of textual labels of anatomical objects of interest identified in the one of the input medical image or the image of the input medical image/text pair, region features of the anatomical objects of interest, or region coordinates of the anatomical objects of interest.

Illustrative embodiment 11. The apparatus according to any one of illustrative embodiments 9-10, wherein: the means for receiving one of 1) an input medical image, 2) input medical text, or 3) an input medical image/text pair comprises: means for receiving one of the input medical text or the input medical image/text pair; and the means for extracting features from the received one of 1) the input medical image, 2) the input medical text, or 3) the input medical image/text pair comprises: means for extracting an SLS (structured language sequence) representation from one of the input medical text or text of the input medical image/text pair; and means for encoding the SLS representation into token embeddings.

Illustrative embodiment 12. The apparatus according to any one of illustrative embodiments 9-11, wherein the means for generating, based on the extracted features and using a trained machine learning based model, one of A) synthetic medical text, B) a synthetic medical image, or C) a synthetic medical image/text pair for the received one of 1) the input medical image, 2) the input medical text, or 3) the input medical image/text pair respectively comprises: means for generating synthetic image features using the trained machine learning based model; and means for generating the synthetic medical image based on the synthetic image features using a machine learning based image generator network.

Illustrative embodiment 13. A non-transitory computer-readable storage medium comprising instructions which, when executed by a computer, cause the computer to carry out operations comprising: receiving one of 1) an input medical image, 2) input medical text, or 3) an input medical image/text pair; extracting features from the received one of 1) the input medical image, 2) the input medical text, or 3) the input medical image/text pair; generating, based on the extracted features and using a trained machine learning based model, one of A) synthetic medical text, B) a synthetic medical image, or C) a synthetic medical image/text pair for the received one of 1) the input medical image, 2) the input medical text, or 3) the input medical image/text pair respectively; and outputting the generated one of A) the synthetic medical text, B) the synthetic medical image, or C) the synthetic medical image/text pair.

Illustrative embodiment 14. The non-transitory computer-readable storage medium according to illustrative embodiment 13, wherein the trained machine learning based model is trained by: during a first training stage, training the trained machine learning based model using a training image/text pair comprising a training medical image and training medical text; and during a second training stage: training the trained machine learning based model using 1) a modified version of the training medical image and 2) the training medical text, and training the trained machine learning based model using 1) a modified version of the training medical text and 2) the training medical image.

Illustrative embodiment 15. The non-transitory computer-readable storage medium according to illustrative embodiment 14, wherein training the trained machine learning based model using 1) a modified version of the training medical image and 2) the training medical text comprises: comparing a synthetic medical image with the training medical text; and comparing the synthetic medical image with the training medical image.

Illustrative embodiment 16. The non-transitory computer-readable storage medium according to any one of illustrative embodiments 14-15, wherein training the trained machine learning based model using 1) a modified version of the training medical text and 2) the training medical image comprises: comparing synthetic medical text with the training medical text; and comparing an SLS (structured language sequence) representation of the synthetic medical text with an SLS representation of the training medical text.

Illustrative embodiment 17. A computer-implemented method comprising: receiving a training medical image/text pair; training a machine learning based model for generating synthetic medical text and a synthetic medical image based on the training medical image/text pair; and outputting the trained machine learning based model.

Illustrative embodiment 18. The computer-implemented method illustrative embodiment 17, wherein the training medical image/text pair comprises a training medical image and training medical text and training a machine learning based model for generating synthetic medical text and a synthetic medical image based on the training medical image/text pair comprises: during a first training stage, training the machine learning based model using the training image/text pair; and during a second training stage: training the machine learning based model using 1) a modified version of the training medical image and 2) the training medical text, and training the machine learning based model using 1) a modified version of the training medical text and 2) the training medical image.

Illustrative embodiment 19. The computer-implemented method according to illustrative embodiment 18, wherein training the machine learning based model using 1) a modified version of the training medical image and 2) the training medical text comprises: generating a synthetic medical image by the machine learning based model from 1) the modified version of the training medical image and 2) the training medical text; comparing the synthetic medical image with the training medical text; and comparing the synthetic medical image with the training medical image.

Illustrative embodiment 20. The computer-implemented method according to any one of illustrative embodiments 18-19, wherein training the machine learning based model using 1) a modified version of the training medical text and 2) the training medical image comprises: generating synthetic medical text by the machine learning based model from 1) the modified version of the training medical text and 2) the training medical image; comparing the synthetic medical text with the training medical text; and comparing an SLS (structured language sequence) representation of the synthetic medical text with an SLS representation of the training medical text.

1. A computer-implemented method comprising:
receiving one of 1) an input medical image, 2) input medical text, or 3) an input medical image/text pair;
extracting features from the received one of 1) the input medical image, 2) the input medical text, or 3) the input medical image/text pair;
generating, based on the extracted features and using a trained machine learning based model, one of A) synthetic medical text, B) a synthetic medical image, or C) a synthetic medical image/text pair for the received one of 1) the input medical image, 2) the input medical text, or 3) the input medical image/text pair respectively; and
outputting the generated one of A) the synthetic medical text, B) the synthetic medical image, or C) the synthetic medical image/text pair.

2. The computer-implemented method of claim 1, wherein:
receiving one of 1) an input medical image, 2) input medical text, or 3) an input medical image/text pair comprises:
receiving one of the input medical image or the input medical image/text pair; and
extracting features from the received one of 1) the input medical image, 2) the input medical text, or 3) the input medical image/text pair comprises:
extracting, from one of the input medical image or an image of the input medical image/text pair, one or more of dense features, tokens embeddings of textual labels of anatomical objects of interest identified in the one of the input medical image or the image of the input medical image/text pair, region features of the anatomical objects of interest, or region coordinates of the anatomical objects of interest.

3. The computer-implemented method of claim 1, wherein:
receiving one of 1) an input medical image, 2) input medical text, or 3) an input medical image/text pair comprises:
receiving one of the input medical text or the input medical image/text pair; and
extracting features from the received one of 1) the input medical image, 2) the input medical text, or 3) the input medical image/text pair comprises:
extracting an SLS (structured language sequence) representation from one of the input medical text or text of the input medical image/text pair; and
encoding the SLS representation into token embeddings.

4. The computer-implemented method of claim 1, wherein generating, based on the extracted features and using a trained machine learning based model, one of A) synthetic medical text, B) a synthetic medical image, or C) a synthetic medical image/text pair for the received one of 1) the input medical image, 2) the input medical text, or 3) the input medical image/text pair respectively comprises:
generating synthetic image features using the trained machine learning based model; and
generating the synthetic medical image based on the synthetic image features using a machine learning based image generator network.

5. The computer-implemented method of claim 1, wherein the trained machine learning based model is trained by:
during a first training stage, training the machine learning based model using a training image/text pair comprising a training medical image and training medical text; and
during a second training stage:
training the machine learning based model using 1) a modified version of the training medical image and 2) the training medical text, and
training the machine learning based model using 1) a modified version of the training medical text and 2) the training medical image.

6. The computer-implemented method of claim 5, wherein training the machine learning based model using 1) a modified version of the training medical image and 2) the training medical text comprises:
generating a synthetic medical image by the machine learning based model from 1) the modified version of the training medical image and 2) the training medical text;
comparing the synthetic medical image with the training medical text; and
comparing the synthetic medical image with the training medical image.

7. The computer-implemented method of claim 5, wherein training the trained machine learning based model using 1) a modified version of the training medical text and 2) the training medical image comprises:
generating synthetic medical text by the machine learning based model from 1) the modified version of the training medical text and 2) the training medical image;
comparing the synthetic medical text with the training medical text; and
comparing an SLS (structured language sequence) representation of the synthetic medical text with an SLS representation of the training medical text.

8. The computer-implemented method of claim 1, wherein the trained machine learning based model is a multimodal transformer network.

9. An apparatus comprising:
means for receiving one of 1) an input medical image, 2) input medical text, or 3) an input medical image/text pair;
means for extracting features from the received one of 1) the input medical image, 2) the input medical text, or 3) the input medical image/text pair;
means for generating, based on the extracted features and using a trained machine learning based model, one of A) synthetic medical text, B) a synthetic medical image, or C) a synthetic medical image/text pair for the received one of 1) the input medical image, 2) the input medical text, or 3) the input medical image/text pair respectively; and
means for outputting the generated one of A) the synthetic medical text, B) the synthetic medical image, or C) the synthetic medical image/text pair.

10. The apparatus of claim 9, wherein:
the means for receiving one of 1) an input medical image, 2) input medical text, or 3) an input medical image/text pair comprises:
means for receiving one of the input medical image or the input medical image/text pair; and
the means for extracting features from the received one of 1) the input medical image, 2) the input medical text, or 3) the input medical image/text pair comprises:
means for extracting, from one of the input medical image or an image of the input medical image/text pair, one or more of dense features, tokens embeddings of textual labels of anatomical objects of interest identified in the one of the input medical image or the image of the input medical image/text pair, region features of the anatomical objects of interest, or region coordinates of the anatomical objects of interest.

11. The apparatus of claim 9, wherein:
the means for receiving one of 1) an input medical image, 2) input medical text, or 3) an input medical image/text pair comprises:
means for receiving one of the input medical text or the input medical image/text pair; and
the means for extracting features from the received one of 1) the input medical image, 2) the input medical text, or 3) the input medical image/text pair comprises:
means for extracting an SLS (structured language sequence) representation from one of the input medical text or text of the input medical image/text pair; and
means for encoding the SLS representation into token embeddings.

12. The apparatus of claim 9, wherein the means for generating, based on the extracted features and using a trained machine learning based model, one of A) synthetic medical text, B) a synthetic medical image, or C) a synthetic medical image/text pair for the received one of 1) the input medical image, 2) the input medical text, or 3) the input medical image/text pair respectively comprises:
means for generating synthetic image features using the trained machine learning based model; and
means for generating the synthetic medical image based on the synthetic image features using a machine learning based image generator network.

13. A non-transitory computer-readable storage medium comprising instructions which, when executed by a computer, cause the computer to carry out operations comprising:
receiving one of 1) an input medical image, 2) input medical text, or 3) an input medical image/text pair;
extracting features from the received one of 1) the input medical image, 2) the input medical text, or 3) the input medical image/text pair;
generating, based on the extracted features and using a trained machine learning based model, one of A) synthetic medical text, B) a synthetic medical image, or C) a synthetic medical image/text pair for the received one of 1) the input medical image, 2) the input medical text, or 3) the input medical image/text pair respectively; and
outputting the generated one of A) the synthetic medical text, B) the synthetic medical image, or C) the synthetic medical image/text pair.

14. The non-transitory computer-readable storage medium of claim 13, wherein the trained machine learning based model is trained by:
during a first training stage, training the trained machine learning based model using a training image/text pair comprising a training medical image and training medical text; and
during a second training stage:
training the trained machine learning based model using 1) a modified version of the training medical image and 2) the training medical text, and
training the trained machine learning based model using 1) a modified version of the training medical text and 2) the training medical image.

15. The non-transitory computer-readable storage medium of claim 14, wherein training the trained machine learning based model using 1) a modified version of the training medical image and 2) the training medical text comprises:
comparing a synthetic medical image with the training medical text; and
comparing the synthetic medical image with the training medical image.

16. The non-transitory computer-readable storage medium of claim 14, wherein training the trained machine learning based model using 1) a modified version of the training medical text and 2) the training medical image comprises:
comparing synthetic medical text with the training medical text; and
comparing an SLS (structured language sequence) representation of the synthetic medical text with an SLS representation of the training medical text.

17. A computer-implemented method comprising:
receiving a training medical image/text pair;
training a machine learning based model for generating synthetic medical text and a synthetic medical image based on the training medical image/text pair; and
outputting the trained machine learning based model.

18. The computer-implemented method of claim 17, wherein the training medical image/text pair comprises a training medical image and training medical text and training a machine learning based model for generating synthetic medical text and a synthetic medical image based on the training medical image/text pair comprises:
during a first training stage, training the machine learning based model using the training image/text pair; and
during a second training stage:
training the machine learning based model using 1) a modified version of the training medical image and 2) the training medical text, and
training the machine learning based model using 1) a modified version of the training medical text and 2) the training medical image.

19. The computer-implemented method of claim 18, wherein training the machine learning based model using 1) a modified version of the training medical image and 2) the training medical text comprises:
generating a synthetic medical image by the machine learning based model from 1) the modified version of the training medical image and 2) the training medical text;
comparing the synthetic medical image with the training medical text; and
comparing the synthetic medical image with the training medical image.

20. The computer-implemented method of claim 18, wherein training the machine learning based model using 1) a modified version of the training medical text and 2) the training medical image comprises:
generating synthetic medical text by the machine learning based model from 1) the modified version of the training medical text and 2) the training medical image;
comparing the synthetic medical text with the training medical text; and
comparing an SLS (structured language sequence) representation of the synthetic medical text with an SLS representation of the training medical text.
